(19) United States
(12) Patent Application Publication
(10) Pub. No.: US 2007/0179223 A1
(43) Pub. Date: Aug. 2, 2007

(54) Flame-retardant acrylic-based thermally conductive sheet

(76) Inventors: Yuji Hiroshige, Tokyo (JP); Yoshinao Yamazaki, Kanagawa (JP); Sawako Nakamura, Kanagawa (JP)

Correspondence Address: 3M INNOVATIVE PROPERTIES COMPANY, PO BOX 33427, ST. PAUL, MN, 55133-3427, US

(21) Appl. No.: 10/596,873

(22) PCT Filed: Jan. 13, 2005
(86) PCT No.: PCT/US05/00897

§ 371 Date: Jun. 28, 2006

(30) Foreign Application Priority Data
Feb. 13, 2004 (JP) 2004-037095

(51) Int. Cl. C08K 5/34; C08K 5/49

(52) U.S. Cl. 524/100; 524/115; 524/495; 524/437; 524/433

(57) ABSTRACT

A thermally conductive sheet made of a composition comprising (A) a (meth)acrylic polymer, (B) a halogen-free flame retardant selected from the group consisting of an organophosphorus compound, a triazine skeleton-containing compound, an expanded graphite and polyphenylene ether, and (C) a hydrated metal compound, wherein the composition including the hydrated metal compound in an amount of 40-90 vol % of the total volume of the composition.

### BACKGROUND

The present invention relates to a flame-retardant acrylic-based thermally conductive sheet.

Various patents disclose flame retardation of resin compositions and flame retardancy is commonly imparted by the addition of flame retardants. Although the addition of halogenated compounds is particularly effective for flame retardation, the use of the halogenated compounds has recently been avoided because problems of environmental pollution may be caused by the halogenated compounds. Various techniques for flame-retarded compounds containing no halogenated compounds are disclosed.

Japanese Unexamined Patent Publication (Kokai) No. 5-170996 and Japanese Unexamined Patent Publication (Kokai) No. 2000-230162 disclose flame retardation due to the addition of organophosphorus compounds. Japanese Unexamined Patent Publication (Kokai) No. 5-170996 provides a composition in which flame retardancy is imparted to fabricated materials such as building materials by adding polyphosphorylated compounds to acrylic-based resins. However, it is considered that the composition has low thermal conductivity. Japanese Unexamined Patent Publication (Kokai) No. 2000-230162 discloses a flame-retardant adhesive composition and an adhesive tape, containing as essential components an acrylate ester copolymer, ammonium polyphosphate, ammonium hydroxide and aliphatic polyhydric alcohol, wherein a ratio of ammonium polyphosphate to aluminum hydroxide is in the range of 8:2-3:7 and the total amount of them is 60-150 parts by weight to 100 parts by weight of the combustible component. It is considered that this composition has comparatively low flame retardancy because of comparatively small content of aluminum hydroxide and a small total amount of ammonium polyphosphate and aluminum hydroxide.

Japanese Unexamined Patent Publication (Kokai) No. 7-268042, Japanese Unexamined Patent Publication (Kokai) No. 10-77308, and Japanese Unexamined Patent Publication (Kokai) No. 2000-313785 disclose a technique for flame retardation by copolymerizing an organophosphorus compound with a composition. Japanese Unexamined Patent Publication (Kokai) No. 7-268042 discloses a graft copolymer containing a rubber skelton, and a graft side branch containing a phosphate ester. Patent Japanese Unexamined Patent Publication (Kokai) No. 10-77308 discloses a pressure-sensitive adhesive tape containing a copolymer obtained from a monomer mixture containing an acrylic-based monomer and a phosphorus element-containing monomer. As is apparent from the disclosed compositions, the compositions described in Patent Japanese Unexamined Patent Publication (Kokai) No. 7-268042 and Japanese Unexamined Patent Publication (Kokai) No. 10-77308 are believed to have poor flame retardancy and poor thermal conductivity. Japanese Unexamined Patent Publication (Kokai) No. 2000-313785 discloses a radical polymerizable composition containing a phosphate ester (meth)acrylate and also discloses that the composition may contain aluminum hydroxide. Since because this phosphate ester contains mono-, di- and tri-functional groups in a certain proportion, comparatively hard cured article is obtained. Also the phosphate ester is not compatible with a long-chain alkyl group (meth)acrylic monomer because of its high polarity, and therefore a copolymer with poor flexibility is obtained. Thus, the composition disclosed in Japanese Unexamined Patent Publication (Kokai) No. 2000-313785 is, as described in its specification, a composition suited for use in the preparation of molded articles such as building materials. As a result, the composition is not suited for use in thermally conductive sheets which require sufficient flexibility.

Japanese Unexamined Patent Publication (Kokai) No. 7-70448 and Japanese National Patent Publication (Kokai) No. 2000-344846 disclose flame-retardant compositions containing a triazine skeleton-containing compound, Japanese Unexamined Patent Publication (Kokai) No. 2003-12867 discloses a flame-retardant resin composition containing an expanded graphite, and Japanese Unexamined Patent Publication (Kokai) No. 5-93107 discloses a flame-retardant resin composition containing a polyphenylene ether resin. Any composition does not have enough flexibility and flame retardancy as a thermally conductive sheet.

Heretofore, silicone resins have widely been used as binders in thermally conductive sheets and the thermally conductive sheets comparatively pass a flame retardancy rating of V0 under Underwriters Laboratories Inc. (UL) Standard No. 94 “Test for Flammability of Plastic Materials for Parts in Devices and Appliances” (1996), hereinafter referred to “UL-94”, comparatively easily, because of high flame retardancy of the silicone resins. However, it has recently been pointed out that a siloxane gas evolved from the silicone resins causes poor contacts of electronic equipments, and thus thermally conductive sheets containing no silicone resins have been studied. Japanese Unexamined Patent Publication (Kokai) No. 11-269438 and Japanese Unexamined Patent Publication (Kokai) No. 2002-294192 disclose flame retardation of these thermally conductive sheets containing no silicone resins. Both thermal conductivity and flame retardancy are imparted to these compositions by adding hydrated metal compounds such as aluminum hydroxide to acrylic-based polymers. However, a large amount of the hydrated metal compounds is required so as to pass the flame retardancy rating of V0 under UL-94, and thus enough flexibility as the thermally conductive sheet can not be achieved.

Japanese Unexamined Patent Publication (Kokai) No. 2003-238760 discloses a composition comprising an ethyl acrylate-based polymer, an ethylene-methyl acrylate copolymer, a hydrated metal compound, red phosphorus and a thermally conductive filler. Although this composition passed the flame retardancy rating of V0, the use of red phosphorus is not preferable in view of safety.

### SUMMARY

According to the present invention, there is provided a thermally conductive sheet made of a composition comprising (A) a (meth)acrylic polymer, (B) a halogen-free flame retardant selected from the group consisting of an organophosphorus compound, a triazine skeleton-containing compound, an expanded graphite and polyphenylene ether, and (C) a hydrated metal compound, wherein the composition includes the hydrated metal compound in an amount of 40-90 vol % of the total volume of the composition. Two or more kinds of the halogen-free flame retardants may be used in combination.

### DETAILED DESCRIPTION

The hydrated metal compound contained in the thermally conductive sheet of the present invention imparts thermal conductivity to the sheet. The hydrated metal compound causes an endothermic reaction, which releases water upon combustion, thereby to exhibit self-extinguishing properties and to impart flame retardancy. By using the hydrated metal compound in combination with the halogen-free flame retardant, flame retardancy can be synergistically enhanced and the thermally conductive sheet of the present invention can achieve high flame retardancy corresponding to a V0 rating under UL-94. By using these flame retardants in combination with the hydrated metal compound, the amount of the flame retardants can be further reduced as compared with the case of using them alone. Therefore, according to the present invention, sufficient flexibility of the sheet can be easily achieved. The flexibility of the sheet reduces thermal resistance and improves thermal conductivity. “(Meth)acrylic” as used herein means acrylic or methacrylic, and “acrylic monomer” and “methacrylic monomer” mean an acrylic-based monomer such as acrylic acid or acrylate ester, or a methacrylic-based monomer such as methacrylic acid or methacrylate ester. “Acrylic polymer” and “(meth)acrylic polymer” mean a polymer obtained by polymerizing a monomer including a (meth)acrylic monomer.

The thermally conductive sheet of the present invention is particularly suited for use as heat radiating means to allow heat from heat generating parts of electronic and electric devices to escape, although its application is not limited. For example, it is possible to prevent fire from occurring due to a temperature rise of electronic parts by disposing the thermally conductive sheet of the present invention between heat generating parts such as integrated circuits (IC) and heat radiating parts such as heat sinks. Since the thermally conductive sheet is exposed to high temperature, flame retardancy is commonly required. Silicone resins, which have widely been used as binder resins of thermally conductive sheets, have high flame retardancy. However, a siloxane gas evolved from the silicone resins causes poor contacts occasionally. In the acrylic-based thermally conductive sheet of the present invention, these problems of contamination do not arise. By adding a hydrated metal compound and a halogen-free flame retardant to an acrylic-based polymer, it is made possible to provide an acrylic-based thermally conductive sheet with high flame retardancy corresponding to a V0 rating under UL-94 without using halogenated compounds with problems of environmental pollution. The thermally conductive sheet of the present invention may be tacky or tack-free.

(Meth)acrylic Polymer

The (meth)acrylic polymer used in the present invention is obtained by polymerizing at least one (meth)acrylic monomer or its partially polymerized polymer. Useful (meth)acrylic monomer is not particularly restricted, and any monomer commonly used for formation of acrylic polymers may be used. Specifically, the (meth)acrylic monomer used is a (meth)acrylic monomer with an alkyl group of 20 carbons or less, and more specifically there may be mentioned ethyl (meth)acrylate, butyl (meth)acrylate, hexyl (meth)acrylate, 2-ethylhexyl (meth)acrylate, octyl (meth)acrylate, isooctyl (meth)acrylate, decyl (meth)acrylate and dodecyl (meth)acrylate. For increased cohesive force of the resulting thermally conductive composition, it is preferred to additionally use a (meth)acrylic monomer with a homopolymer glass transition temperature of 20° C. or higher. As such monomers there may be mentioned carboxyl acids and their corresponding anhydrides, such as acrylic acid and its anhydride, methacrylic acid and its anhydride, itaconic acid and its anhydride, and maleic acid and its anhydride. Other examples of (meth)acrylic monomers with homopolymer glass transition temperatures of 20° C. or higher include cyanoalkyl (meth)acrylates, acrylamide, substituted acrylamides such as N,N′-dimethylacrylamide, and polar nitrogen-containing materials such as N-vinylpyrrolidone, N-vinylcaprolactam, N-vinylpiperidine and acrylonitrile. Other monomers include tricyclodecyl (meth)acrylate, isobomyl (meth)acrylate, hydroxy (meth)acrylate and vinyl chloride. The (meth)acrylic monomer with a glass transition temperature of 20° C. or higher is included in an amount of no more than 100 parts by weight to 100 parts by weight of the (meth)acrylic monomer with an alkyl group of 20 carbons or less.

Hydrated Metal Compound

The thermally conductive sheet of the present invention contains a hydrated metal compound. As useful hydrated metal compounds there may be mentioned aluminum hydroxide, magnesium hydroxide, barium hydroxide, calcium hydroxide, dawsonite, hydrotalcite, zinc borate, calcium aluminate and zirconium oxide hydrate. These hydrated metal compounds may be used alone, or two or more kinds of them may be used in combination. The amount of the hydrated metal compound is in the range of 40-90 vol % of the total volume of the composition constituting the resulting thermally conductive sheet. If the amount of the hydrated metal compound is less than 40 vol %, the flame-retardant effect is reduced, while if it is greater than 90 vol %, the strength and flexibility of the sheet are weakened. In other embodiments, the amount of the hydrated metal compound is in the range of 45-80 vol %, and 48-60 vol %, of the total volume of the composition constituting the resulting thermally conductive sheet. The hydrated metal compound is usually added in the form of particles, and the group of large-sized particles with a mean particle size of 10-500 μm and the group of small-sized particles with a mean particle size of less than 10 μm may be used in combination so as to increase the amount of hydrated metal compound that can be loaded. For improved sheet strength, a filler which has been surface-treated with silane, titanate or the like may be used.

For improved thermal conductivity, a thermally conductive filler may be added, in addition to the hydrated metal compound. As thermally conductive fillers, there may be used ceramics, metal oxides, metal and the like. To increase the amount of these fillers that can be loaded, large-sized fillers with a mean particle size of 10-500 μm and small-sized fillers with a mean particle size of less than 10 μm are desirably used in combination. Alternatively, the large-sized hydrated metal compound and/or large-sized fillers each having a mean particle size of 10-500 μm and the small-sized hydrated metal compound and/or small-sized fillers each having a mean particle size of less than 10 μm may be used in combination. For improved sheet strength, a filler which has been surface-treated with silane, titanate or the like may be used.

Halogen-free Flame Retardant

The thermally conductive sheet of the present invention contains a halogen-free flame retardant, together with the hydrated metal compound. As halogen-free flame retardants there may be mentioned (1) an organophosphorus compound, (2) a triazine skeleton-containing compound, (3) an expanded graphite and (4) polyphenylene ether, and two or more kinds of these halogen-free flame retardants may be used in combination.

Organophosphorus Compound

The organophosphorus compound may be copolymerizable with a (meth)acrylic monomer, or may not be substantially copolymerizable with the (meth)acrylic monomer. As the organophosphorus compound which may be copolymerizable with the (meth)acrylic monomer, a phosphate ester-containing (meth)acrylic monomer is useful and is represented, for example, by the following formula.

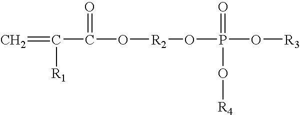

In the formula, R₁ represents hydrogen or a methyl group, R₂ represents an alkylene group with 1-4 carbon atoms, and R₃ and R4 each represents an alkyl group or an aryl group. Specifically, there may be mentioned dimethyl phosphate-(meth)acryloyloxymethyl, diethyl phosphate-(meth)acryloyloxymethyl, diphenyl phosphate-(meth)acryloyloxymethyl, dimethyl phosphate-2-(meth)acryloyloxyethyl, diethyl phosphate-2-(meth)acryloyloxyethyl, diphenyl phosphate-2-(meth)acryloyloxyethyl, dimethyl phosphate-3-(meth)acryloyloxypropyl, diethyl phosphate-3-(meth)acryloyloxypropyl and diphenyl phosphate-3-(meth)acryloyloxypropyl. Two or more kinds of these phosphate ester-containing (meth)acrylic monomers may be used in combination. These phosphate ester-containing (meth)acrylic monomers are y added in an amount in the range of 5-100 parts by weight, and in other embodiments, 5-50 parts by weight to 100 parts by weight of the (meth)acrylic monomer. If the amount of the ester-containing (meth)acrylic monomer is less than 5 parts by weight, less flame-retardant effect is exerted, while if it is greater than 100 parts by weight, the flexibility of the sheet is weakened.

As the organophosphorus compound which may not be substantially copolymerizable with the (meth)acrylic monomer, there may be mentioned phosphate esters, aromatic condensed phosphate esters and polyphosphate esters. Specific examples of phosphate esters include triphenyl phosphate, tricresyl phosphate, cresyldiphenyl phosphate, 2-ethylhexyldiphenyl phosphate, tri-n-butyl phosphate, trixylenyl phosphate, resorcinol(bis)diphenyl phosphate and bisphenol A bis(diphenyl phosphate). Specific examples of polyphosphate ester include ammonium polyphosphate, ammonium melamine-modified polyphosphate and coated ammonium polyphosphate. As used herein, the coated ammonium polyphosphate refers to ammonium polyphosphate whose water resistance is improved by coating with a resin or encapsulation. These organophosphoric acid compounds are added in an amount in the range of 5-100 parts by weight, and in other embodiments, 5-50 parts by weight to 100 parts by weight of the (meth)acrylic monomer. If the amount of the organophosphorus compound is less than 5 parts by weight, less flame-retardant effect is exerted, while if it is greater than 100 parts by weight, a cohesive force of the sheet is lost occasionally.

Triazine Skeleton-containing Compound

The triazine skeleton-containing compound may be copolymerizable with a (meth)acrylic monomer, or may not be substantially copolymerizable with the (meth)acrylic monomer. As the triazine skeleton-containing compound which may be copolymerizable with the (meth)acrylic monomer, for example, there may be mentioned tris(acryloxyethyl) isocyanurate and triallyl isocyanurate. As the triazine skeleton-containing compound which may not be substantially copolymerizable with the (meth)acrylic monomer, for example, there may be mentioned melamine, melamine resin and polycyanurate. These triazine skeleton-containing compounds are added in an amount in the range of 0.5-100 parts by weight, and in other embodiments, 0.5-50 parts by weight to 100 parts by weight of the (meth)acrylic monomer. If the amount of the triazine skelton-containing compound is less than 0.5 parts by weight, less flame-retardant effect is exerted, while if it is greater than 100 parts by weight, the flexibility of the sheet is lost occasionally.

Expanded Graphite

The expanded graphite restricts supply of oxygen to combustion parts and intercepts heat due to expansion upon combustion, and thus exhibits flame retardancy. The expanded graphite is desirably added in an amount in the range of 1-100 parts by weight, and in other embodiments, from 1-50 parts by weight to 100 parts by weight of the (meth)acrylic monomer. If the amount of the expanded graphite is less than 1 part by weight, less flame-retardant effect is exerted, while if it is greater than 100 parts by weight, the flexibility of the sheet is lost occasionally.

Polyphenylene Ether

Since the polyphenylene ether is hardly compatible with a (meth)acrylic polymer, it is incorporated into the composition by adding in the form of powder to components such as (meth)acrylic monomer and its partially polymerized polymer, followed by mixing and polymerization. As the polyphenylene ether, for example, Polyphenylene Powder S202A (product of Asahikasei Chemicals) can be used. The polyphenylene ether is added in an amount in the range of 1-100 parts by weight, and in other embodiments, from 1-50 parts by weight to 100 parts by weight of the (meth)acrylic monomer. If the amount of the polyphenylene ether is less than 1 part by weight, less flame-retardant effect is exerted, while if it is greater than 100 parts by weight, the flexibility of the sheet is lost occasionally.

Optional Components

The composition constituting the thermally conductive composition of the invention may also contain arbitrary additives such as crosslinking agents, plasticizers, chain transfer agents, tackifiers, antioxidants, auxiliary flame retardants, anti-settling agents, thickeners, thixotropic agents, surfactants, surface-treating agents, antifoaming agents, coloring agents and the like so as to obtain preferable physical properties.

Process for Production of Thermally Conductive Sheet

The thermally conductive sheet of the present invention is produced by polymerizing a precursor mixture containing at least one (meth)acrylic-based monomer or its partially polymerized polymer, a hydrated metal compound, a halogen-free flame retardant and an optional polymerization initiator, for example, photoinitiator or thermal initiator, so as to be formed into a sheet. Since the (meth)acrylic monomer itself commonly has low viscosity, when a precursor mixture containing a (meth)acrylic monomer is mixed with other components such as hydrated metal compound, these components settle occasionally. In such a case, the (meth)acrylic monomer is previously thickened by partial polymerization, preferable. The partial polymerization is desirably carried out so as to ensure a viscosity of approximately 100-10,000 centipoise (cP). The partial polymerization can be carried out by various methods and examples thereof include thermal polymerization, ultraviolet polymerization, electron beam polymerization, y-ray radiation polymerization and ionization-ray polymerization.

In the partial polymerization, thermal polymerization initiators or photopolymerization initiators are commonly used. As thermal polymerization initiators, there can be used organic peroxide free radical initiators such as diacyl peroxides, peroxyketals, ketone peroxides, hydroperoxides, dialkyl peroxides, peroxyesters and peroxydicarbonates. Specifically there may be mentioned lauroyl peroxide, benzoyl peroxide, cyclohexanone peroxide, 1,l-bis(t-butylperoxy)3,3,5-trimethylcyclohexane and t-butylhydroperoxy. Alternatively, persulfate/bisulfite combinations may also be used.

As photopolymerization initiators, there may be mentioned benzoin ethers such as benzoin ethyl ether and benzoin isopropyl ether, anisoin ethyl ether and anisoin isopropyl ether, Michler's ketone (4,4′-tetramethyldiaminobenzophenone), or substituted acetophenones such as 2,2-dimethoxy-2-phenylacetophenone (for example, KB-1 by Sartomer; Irgacure™ 651 by Ciba-Specialty Chemical) and 2,2-diethoxyacetophenone. In addition, there may be mentioned substituted a-ketols such as 2-methyl-2-hydroxypropiophenone, aromatic sulfonyl chlorides such as 2-naphthalenesulfonyl chloride, and photoactive oxime-based compounds such as 1-phenone-1,1-propanedione-2-(o-ethoxycarbonyl)oxime. Any combination of the foregoing thermal polymerization initiators or photopolymerization initiators may also be used.

The amount of the initiator used for partial polymerization is not particularly restricted, but will normally be 0.001-5 parts by weight to 100 parts by weight of the (meth)acrylic monomer.

For the partial polymerization, the thermal polymerizing binder component may include a chain transfer agent to control the molecular weight and the content of the polymer included in the obtained partially polymerized polymer. Examples of the chain transfer agent include mercaptans, disulfides, carbon tetrabromide, carbon tetrachloride or the like, and combination thereof. If used, the transfer agent is generally used in an amount of 0.01-1.0 parts by weight, and in other embodiments, from 0.02-0.5 parts by weight based on 100 parts by weight of the (meth)acrylic monomer.

A crosslinking agent may be used to increase the strength when the obtained thermally conductive composition is processed into a sheet form or the like. As crosslinking agents, heat-activated crosslinking agents may also be used. Also included are lower alkoxylated aminoformaldehyde condensates with 14 carbon atoms in the alkyl group, hexamethoxymethylmelamine (for example, Cymell™ 303 by American Cyanamide), tetramethoxymethylurea (for example, Beetle™ 65 by American Cyanamide) or tetrabutoxymethylurea (Beetle™ 85). Other useful crosslinking agents include polyfunctional acrylates such as 1,6-hexanediol diacrylate and tripropyleneglycol diacrylate. The crosslinking agent will usually be used in an amount of 0.001-5 parts by weight, and in other embodiments, from 0.01-1 parts by weight to 100 parts by weight of the monomer. Combinations of the foregoing crosslinking agents may also be used.

The foregoing (meth)acrylic-based monomer or its partially polymerized polymer, or a mixture of the foregoing monomer and its partially polymerized polymer, a hydrated metal compound and a halogen-free flame retardant are added, and an optional polymerization initiator is added to form a precursor composition. The polymerization can be carried out by various methods and examples thereof include thermal polymerization, ultraviolet polymerization, electron beam polymerization, y-ray radiation polymerization and ionization-ray polymerization.

The precursor composition contains the thermal polymerization initiator described in the explanation of the partial polymerization in case of the thermal polymerization. In case of the photopolymerization such as ultraviolet polymerization, the precursor composition contains the photopolymerization initiator described in the explanation of the partial polymerization. In case of the polymerization with particle energy line such as electron beam polymerization, no polymerization initiator is usually required. In case of the thermal polymerization, the polymerization reaction is carried out by heating the precursor composition to a temperature in the range of approximately 50-200° C.

In case the precursor composition is polymerized by the ultraviolet polymerization, it is deaired and mixed by a planetary mixer or the like. The resulting polymerizing mixture is formed into a sheet, which is exposed to ultraviolet rays to obtain a thermally conductive sheet. In case a large amount of the hydrated metal compound is loaded, penetration of ultraviolet rays is restricted occasionally. In such a case, the foregoing thermal polymerization is desirably used.

When a thermally conductive sheet is produced, the polymerization is desirably carried out after application or coating of the composition onto a support surface such as a release liner and forming a sheet by calendering or press molding, in order to obtain a thermally conductive sheet according to the invention. The sheet may be formed in an inert atmosphere of nitrogen or the like in order to prevent inhibition of polymerization by oxygen.

The thermally conductive sheet can also be produced by dissolving a (meth)acrylic-based polymer in a proper solvent such as ethyl acetate, adding other components such as hydrated metal compound to form a solution, and removing the solvent by heating while uniformly dispersing the components. The thermally conductive sheet according to the present invention can be obtained by applying or coating of the solution onto a support surface such as a release liner, forming a sheet by calendering or press molding, removing the solvent from the solution and drying the sheet.

Use

The acrylic-based thermally conductive composition and thermally conductive sheet according to the present invention can be used for adhesion of heat sinks or heat radiators to electronic parts, and particularly semiconductor/electronic parts such as power transistors, graphic IC, chip sets, memory chips, central processing units (CPUs) and the like. A thickness of the sheets are mainly determined by considering a thermal resistance of the portions to be applied. Typically, the sheets desirably have a thickness of 5 mm or less. However, when filled into a gap between a larger heat generating part and heat dissipating part, or applied to conform to irregularity of a part surface, sheets having a thickness greater than 5 mm may be suitable. When sheets having a thickness greater than 5 mm are suitable, thickness of the sheets is desirably less than 10 mm.

The thermally conductive sheet is provided by forming a thermally conductive composition layer on a release treated support or base which is releasable with respect to the thermally conductive composition. In this case, release of the support or base from the sheet during use will allow the latter to serve as a free-standing film. The thermally conductive sheet may also be used while anchored to the support or base for improved sheet strength. Polymer films are typical as supports or bases, and for example there may be used films of polyethylene, polypropylene, polyinide, polyethylene terephthalate, polyethylene naphthalate, polytetrafluoroethylene, polyether ketone, polyethersulfone, polymethylterpene, polyetherimide, polysulfone, polyphenylene sulfide, polyamidoimide, polyesterimide and aromatic arnides. When heat resistance is a particularly required, a polyimide film or polyamidoirnide film is preferred. The thermal conductivity may also be increased by adding a thermally conductive filler to the support or base. As supports or bases there may be mentioned metal foils of aluminum, copper or the like, or woven, nonwoven fabrics or scrims formed from glass fibers, carbon fibers, nylon fibers or polyester fibers, or such fibers that have been coated with a metal. The support or base may be present on one or both surfaces of the sheet, or it may be embedded in the sheet.

The thermally conductive sheet according to the present invention has high flame retardancy corresponding to a V0 rating under UL-94 as a result of a combination of a hydrated metal compound and a halogen-free flame retardant. Since these flame retardants are used in combination with the hydrated metal compound, its amount can be further reduced as compared with the case of using them alone. Therefore, according to the present invention, sufficient flexibility of the sheet can be easily achieved. The thermally conductive sheet according to the present invention has enough hardness as a thermally conductive sheet to which high flexibility is required, for example, E type hardness (JIS K6253) of 10-80, in other embodiments, from 20-70. The thermally conductive sheet has high thermal conductivity of 1.0 W/mK or greater.

The following test is performed in accordance with UL-94. The sample of a thermally conductive sheet measuring 13 mm×125 mm is vertically disposed and its one end is held by a holding clamp. At this time, cotton is placed 30 cm below the sample. The other end (free end) of the sample is caused to contact the flame of a burner for 10 seconds (first application) and, after the flame extinguishes, the flame of the burner is further applied for 10 seconds (second application). Two sets of tests are performed for 5 samples. With regard for the respective samples, the following recordings are performed:
Duration of flaming combustion after application of the first burner flame,
Duration of flaming combustion after application of the second burner flame,
Duration of glowing combustion after application of the second burner flame,
whether or not dripped flaming particles may ignite cotton placed below the sample, and
whether or not the sample may burn up to the holding clamp.

Standards that pass “V-0” rating are as follows:
the total flaming combustion for the respective samples is 10 seconds or less,
the total flaming combustion time for all sets of all 5 samples is 50 seconds or less,
the total flaming and glowing combustions for the respective samples after application of
the second burner flame are 30 seconds or less,
dripped flaming particles from the sample do not ignite cotton, and
none of the samples burnt by glow or flame combustion up to the holding clamp.

Using a sample with thickness of 10 mm obtained by laminating thermally conductive sheets measuring 50 mm×120 mm, thermal conductivity is measured by a thermal conductivity meter QTM-D3 (available from Kyoto Electronic Manufacturing Co., Ltd.) in accordance with a hot wire method in accordance with JIS R2618.

### EXAMPLES

### Examples 1-5

As a flame retardant, a phosphate ester-containing (meth)acrylate, which is copolymerizable with a (meth)acrylic monomer, was used.

1. Production of Partially polymerized Polymer

100 Parts by weight of 2-ethylhexyl acrylate (2EHA) and 0.04 parts by weight of an ultraviolet polymerization initiator (Irgacure™ 651, product of Ciba-Specialty Chemical) were mixed, and the mixture was exposed to ultraviolet rays at an intensity of 3 mW/cm² using ultraviolet light source having maximum intensity at wave length of 300-400 nm to obtain a partially polymerized polymer with a viscosity of approximately 1000 centipoise (cP). The partially polymerized polymer was a thickened liquid as a result of partial polymerization of the total (meth)acrylic monomer.

2. Fabrication of thermally conductive composition

The composition obtained by deaerating and kneading each of the components in the compositions listed in Table 1 below by a mixer was sandwiched between two polyethylene terephthalate (PET) liners coated with a silicone releasing agent and subjected to calendering. The molding was followed by heating in an oven at 140° C. for 15 minutes for thermal polymerization, to obtain a thermally conductive sheet with thickness of 1 mm.

3. Combustion Test

In accordance with UL-94, a combustion test was performed. The test procedure is as described in detail hereinabove. The results are shown in Table 1.

4. Thermal Conductivity

Using a sample with thickness of 1 mm obtained by laminating ten thermally conductive sheets, thermal conductivity was measured by a thermal conductivity meter QTM-D3 (available from Kyoto Electronic Manufacturing Co., Ltd.). The test procedure is as described in detail hereinabove. The results are shown in Table 1.

5. Measurement of Hardness

Using a sample with thickness of 1 mm obtained by laminating ten thermally conductive sheets, hardness was measured in accordance with JIS K6253. The results are shown in Table 1.

### Comparative Examples 1 and 2

As Comparative Example 1, a thermally conductive sheet containing no phosphate ester (meth)acrylate was produced. As Comparative Example 2, a thermally conductive sheet containing a small amount (35 vol %) of a hydrated metal compound was produced. In the same manner as in Example 1, thermally conductive sheets were produced using the composition obtained from each of the components in the compositions listed in Table 1, and the combustion test, measurement of thermal conductivity and measurement of hardness were performed. The results are shown in Table 1.

### Comparative Example 3

Phosphate ester (meth)acrylate MR200 disclosed in Japanese Unexamined Patent Publication (Kokai) No. 2000-313785 (mixture of 40% by weight of mono(2-methacryloyloxyethyl)acid phosphate and 60% by weight of di(2-methacryloyloxyethyl)acid phosphate, product of DAIHACHI CHEMICAL INDUSTRY CO., LTD.) was used. Although the components in the compositions listed in Table 1 were mixed, 2-EHA monomer was not compatible with a phosphate-containing monomer and a thermally conductive sheet could not be obtained.

TABLE 1

| Example | Example | Example | Example | Example | Comparative | Comparative | Comparative |
|---|---|---|---|---|---|---|---|
| 1 | 2 | 3 | 4 | 5 | Example 1 | Example 2 | Example 3 |

Binder components
(parts by weight)

| Partially polymerized | 20 | 10 | 5 | 5 | 5 | 5 | 5 | 5 |
|---|---|---|---|---|---|---|---|---|
| polymer | | | | | | | | |
| 2EHA | 65 | 75 | 85 | 90 | 85 | 95 | 85 | 85 |
| MR260 | 15 | 15 | 15 | 5 | 10 | — | 10 | — |
| MR200 | — | — | — | — | — | — | — | 10 |
| HDDA | 0.15 | 0.15 | 0.15 | 0.10 | 0.10 | 0.10 | 0.15 | 0.15 |
| Irganox 1076 | 0.3 | 0.3 | 0.3 | 0.3 | 0.3 | 0.3 | 0.3 | 0.3 |
| S151 | 4.0 | 3.0 | — | 3.0 | — | 3.0 | 3.0 | 3.0 |
| TCPC | 0.05 | 0.05 | 0.05 | 0.05 | 0.05 | 0.05 | 0.05 | 0.05 |
| TMCH | 0.80 | 0.80 | 0.80 | 0.80 | 0.80 | 0.80 | 0.80 | 0.80 |
| UP1000 | 30 | 25 | 25 | — | — | — | 20 | 20 |
| Phosphorus content of | 1.0 | 1.0 | 1.0 | 0.4 | 0.8 | 0 | 0.7 | — |
| binder (% by weight) | | | | | | | | |
| Thermally conductive | | | | | | | | |
| composition | | | | | | | | |
| (parts by volume) | | | | | | | | |
| Binder component | 45 | 45 | 45 | 40 | 40 | 40 | 50 | — |
| Total filler amount | 55 | 55 | 55 | 60 | 60 | 60 | 50 | — |
| Filler component | | | | | | | | |
| (parts by volume) | | | | | | | | |
| Aluminum hydroxide 1 | 50 | 45 | — | 60 | — | 60 | 35 | — |
| Aluminum hydroxide 2 | — | — | 12 | — | — | — | — | — |
| B703T | — | — | 36 | — | 30 | — | — | — |
| N4 | — | — | — | — | 30 | — | — | — |
| Silicon carbide | 5 | 10 | 7 | — | — | — | 15 | — |
| Flame retardancy | V0 | V0 | V0 | V0 | V0 | Drip | Drip | — |
| Thermal conductivity | 1.4 | 1.5 | 1.4 | 1.6 | 1.6 | 1.6 | 1.5 | — |
| (W/mk) | | | | | | | | |
| Hardness | 30 | 50 | 40 | 62 | 64 | 61 | 38 | — |

Abbreviations of Compounds in the Table
2EHA: 2-ethylhexyl acrylate
HDDA: hexanediol diacrylate
MR260: diphenyl-2-methacryloyloxyethyl phosphate (product of DAIHACHI CHEMICAL INDUSTRY CO., LTD.)
MR200: mixture of 40% by weight of mono(2-methacryloyloxyethyl)acid phosphate and
60% by weight of di(2-methacryloyloxyethyl)acid phosphate (product of DAIHACHI CHEMICAL INDUSTRY CO., LTD.)
Irganox 1076: antioxidant (product of Ciba-Specialty Chemical)
S151: titanate-based coupling agent (product of NIPPON SODA CO., LTD.)
TCPC: bis(4-t-butylcyclohexyl)peroxydicarbonate
TMCH: 1,1-bis(t-hexylperoxy)3,3,5-trimethylcyclohexane
UP1000: liquid polyacrylate, molecular weight: 3000, Tg: −55° C. (product of Toa Gosei
Chemical Industries Co., Ltd.) (added as a plasticizer)
Aluminum hydroxide 1: mean particle size: 4 μm (Nippon Light Metal Co., Ltd.)
Aluminum hydroxide 2: mean particle size: 55 μm (Nippon Light Metal Co., Ltd.)
B703T: aluminum hydroxide treated with a titanate-based coupling agent, mean particle
size: 2 μm (Nippon Light Metal Co., Ltd.)
N4: magnesium hydroxide treated with fatty acid, mean particle size: 1 μm (product of
Kamishima Chemical Co., Ltd.)
Silicon carbide: mean particle size: 70 μm (Showa Denko K.K.)

### Examples 6-16

An organophosphoric acid compound, which is not substantially copolymerizable with a (meth)acrylic monomer, an expanded graphite, polyphenylene ether and a triazine skeleton-containing compound were used to prepare thermally conductive sheets. In the same manner as in Example 1, thermally conductive sheets were produced using the composition obtained from each of the components in the compositions listed in Table 2, and the combustion test, measurement of thermal conductivity and measurement of hardness were performed. The results are shown in Table 2.

TABLE 2

| Example | Example | Example | Example | Example | Example | Example | Example | Example | Example | Example |
|---|---|---|---|---|---|---|---|---|---|---|
| 6 | 7 | 8 | 9 | 10 | 11 | 12 | 13 | 14 | 15 | 16 |

Binder
components
(parts by
weight)

| Partially | 5 | 5 | 5 | 5 | 5 | — | — | — | — | — | — |
|---|---|---|---|---|---|---|---|---|---|---|---|
| polymerized | | | | | | | | | | | |
| polymer | | | | | | | | | | | |
| 2EHA | 95 | 95 | 95 | 95 | 95 | 100 | 100 | 100 | 100 | 100 | 100 |
| HDDA | 0.10 | — | — | 0.10 | 0.10 | 0.10 | — | | — | — | — |
| TAIC | — | 1.5 | 1.2 | — | — | — | 1.2 | 1.2 | 1.2 | 1.2 | 1.2 |
| Irganox 1076 | 0.3 | 0.3 | 0.3 | 0.3 | 0.3 | 0.3 | 0.3 | 0.3 | 0.3 | 0.3 | 0.3 |
| S151 | 3.0 | — | — | — | — | — | — | — | — | — | — |
| TCPC | 0.05 | 0.05 | 0.05 | 0.05 | 0.05 | 0.05 | 0.05 | 0.05 | 0.05 | 0.05 | 0.05 |
| TMCH | 0.80 | 0.80 | 0.80 | 0.80 | 0.80 | 0.80 | 0.80 | 0.80 | 0.80 | 0.80 | 0.80 |
| UP1000 | 30 | | | | | 25 | 15 | 25 | | | |
| TEGDE | | | | | | | | | 25 | 25 | 25 |
| TPP | 20 | 15 | | | | | | | | | |
| TCP | | | 18 | 10 | | | | | | | |
| AP422 | | | | 10 | 20 | | | | | | |
| AP462 | | | | | | 25 | 15 | | 15 | | |
| AP750 | | | | | | | | 15 | | | |
| GREP-EG | | | | | | | | | | 15 | |
| S202A | | | | | | | | | | | 15 |
| Phosphorus | 1.5 | 1.0 | 1.3 | 3.3 | 5.2 | 4.8 | 3.3 | 3.2 | 3.1 | 0 | 0 |
| content of | | | | | | | | | | | |
| binder | | | | | | | | | | | |
| (% by weight) | | | | | | | | | | | |
| Thermally | | | | | | | | | | | |
| conductive | | | | | | | | | | | |
| composition | | | | | | | | | | | |
| (parts by | | | | | | | | | | | |
| volume) | | | | | | | | | | | |
| Binder | 45 | 45 | 45 | 45 | 45 | 45 | 45 | 45 | 45 | 45 | 45 |
| component | | | | | | | | | | | |
| Total filler | 55 | 55 | 55 | 55 | 55 | 55 | 55 | 55 | 55 | 55 | 55 |
| amount | | | | | | | | | | | |
| Filler | | | | | | | | | | | |
| component | | | | | | | | | | | |
| (parts by | | | | | | | | | | | |
| volume) | | | | | | | | | | | |
| Aluminum | 55 | 50 | 50 | 50 | 50 | 50 | 50 | 50 | 50 | 50 | 50 |
| hydroxide 1 | | | | | | | | | | | |
| Silicon carbide | — | 5 | 5 | 5 | 5 | 5 | 5 | 5 | 5 | 5 | 5 |
| Flame | V0 | V0 | V0 | V0 | V0 | V0 | V0 | V0 | V0 | V0 | V0 |
| retardancy | | | | | | | | | | | |
| Thermal | 1.4 | 1.4 | 1.4 | 1.4 | 1.4 | 1.4 | 1.4 | 1.4 | 1.4 | 1.4 | 1.4 |
| conductivity | | | | | | | | | | | |
| (W/mK) | | | | | | | | | | | |
| Hardness | 48 | 53 | 46 | 53 | 66 | 48 | 60 | 53 | 35 | 50 | 58 |

Abbreviations of Compounds in the Table
TAIC: triallyl isocyanurate
TEGDE: tetraethylene glycol di-2-ethyl hexonate (added as a plasticizer)
TPP: triphenyl phosphate
TCP: tricresyl phosphate
AP422: ammonium polyphosphate (product of Clariant)
AP462: ammonium polyphosphate surface-treated with melamine (product of Clariant)
AP750: ammonium polyphosphate-based flame retardant (product of Clariant)
GREP-EG: expanded graphite (product of TOSOH CORPORATION)
S202A: polyphenylene ether (product of Asahikasei Chemicals)

### Example 17

A phosphate ester-containing (meth)acrylic monomer, which is copolymerizable with an acrylic binder, was used. A polymer was formed by ultraviolet polymerization.

4 Parts by weight of a partially polymerized polymer prepared in the same manner as in Example 1, 90 parts by weight of 2-EHA, 10 parts by weight of MR260, 0.072 parts by weight of HDDA, 0.3 parts by weight of Irganox™ 1076, 0.3 parts by weight of S151, 0.36 parts by weight of Irgacure™ 651 (product of Ciba-Specialty Chemical) as a photoinitiator and 30 parts by weight of UP1000 were mixed to obtain a binder component. The phosphorus content of the binder component was 0.6% by weight. The composition obtained by mixing 40 vol % of a binder component and 60 vol % of aluminum hydroxide 1 (mean particle size: 4 μm), deaerating and kneading the mixture was sandwiched between polyester film liners and subjected to calendering. The molded body with thickness of 0.1 mm was exposed on its both sides to ultraviolet rays at an intensity of 5 mW/cm² via the polyester film liner for about 10 minutes using a low pressure mercury lamp, thereby to photopolymerize the monomer in the mixed solution, and thus a thermally conductive sheet was obtained. After the resulting sheets were laminated to obtain a sample, the combustion test, measurement of thermal conductivity and measurement of hardness were performed in the same manner as in Example 1. As a result, the sample passed a V0 rating and had thermal conductivity of 1.6 W/mK and hardness of 55.

### Example 18

Using an organophosphoric acid compound, which is not substantially copolymerizable with a (meth)acrylic monomer, a flame-retardant thermally conductive sheet was produced by ultraviolet polymerization.

100 Parts by weight of 2-EHA, 0.10 parts by weight of HDDA, 0.3 parts by weight of Irganox™ 1076, 2 parts by weight of S151, 0.40 parts by weight of Irgacure™ 651 (product of Ciba-Specialty Chemical) as a photoinitiator, 8 parts by weight of TCP and 10 parts by weight of AP462 were mixed to obtain a binder component. The phosphorus content of the binder component was 3.0% by weight. The composition obtained by mixing 42 vol % of a binder component, 55 vol % of aluminum hydroxide 1 (mean particle size: 4 μm) and 3 vol % of silicon carbide (mean particle size: 70 μm), deaerating and kneading the mixture was sandwiched between polyester film liners and subjected to calendering. The molded body with thickness of 0.1 mm was exposed on its both sides to ultraviolet rays at an intensity of 5 mW/cm² via the polyester film liner for about 10 minutes using a low pressure mercury lamp, thereby to photopolymerize the monomer in the mixed solution, and thus a thermally conductive sheet was obtained. After the resulting sheets were laminated to obtain a sample, the combustion test, measurement of thermal conductivity and measurement of hardness were performed in the same manner as in Example 1. As a result, the sample passed a V0 rating and had thermal conductivity of 1.5 W/mK and hardness of 65.

### Results

A thermally conductive sheet having high flame retardancy corresponding to a V0rating under UL-94 was obtained by mixing both a flame retardant and a hydrated metal compound. It has been found that the thermally conductive sheet has hardness suited for practical use, and high thermal conductivity.

1. A thermally conductive sheet made of a composition comprising (A) a (meth)acrylic polymer, (B) a halogen-free flame retardant selected from the group consisting of an organophosphorus compound, a triazine skeleton-containing compound, an expanded graphite and polyphenylene ether, and (C) a hydrated metal compound, wherein the composition includes the hydrated metal compound in an amount of 40-90 vol % of the total volume of the composition.

2. A thermally conductive sheet according to claim 1, wherein the hydrated metal compound is selected from the group consisting of aluminum hydroxide, magnesium hydroxide, barium hydroxide, calcium hydroxide, dawsonite, hydrotalcite, zinc borate, calcium aluminate and zirconium oxide hydrate.

3. A thermally conductive sheet according to claim 1, wherein the halogen-free flame retardant is an organophosphorus compound and is included in an amount of 5-100 parts by weight to 100 parts by weight of the (meth)acrylic monomer constituting the (meth)acrylic polymer.

4. A thermally conductive sheet according to claim 1, wherein the halogen-free flame retardant is a triazine skeleton-containing compound and is included in an amount of 0.5-100 parts by weight to 100 parts by weight of the (meth)acrylic monomer constituting the (meth)acrylic polymer.

5. A thermally conductive sheet according to claim 1, wherein the halogen-free flame retardant is an expanded graphite and is included in an amount of 1-100 parts by weight to 100 parts by weight of the (meth)acrylic monomer constituting the (methl)acrylic polymer.

6. A thermally conductive sheet according to claim 1, wherein the halogen-free flame retardant is polyphenylene ether and is included in an amount of 1-100 parts by weight to 100 parts by weight of the (meth)acrylic monomner constituting the (meth)acrylic polymer.

7. A thermally conductive sheet according to claim 3, wherein the halogen-free flame retardant is an organophosphorus compound which is copolymerizable with the (meth)acrylic monomer.

8. A thermally conductive sheet according to claim 1, which achieves high flame retardancy corresponding to a V0 rating under Underwriters Laboratories Inc. (UL) Standard No. 94.
